(19) United States
(12) Patent Application Publication
(10) Pub. No.: US 2026/0235671 A1
(43) Pub. Date: Aug. 13, 2026

(54) FUNCTIONAL VERIFICATION

(71) Applicant: Arm Limited, Cambridge (GB)

(72) Inventors: Benoit Jean Humbert de Sauvan D’ARAMON, Cambridge (GB); Andrew Campbell BETTS, Cambridge (GB); Jatin BHARTIA, Cambridge (GB); Alexandru-Ioan POP, Cambridge (GB); Simone PONZIO, Cambridge (GB); Javier CASTILLO VILAR, Cambridge (GB)

(21) Appl. No.: 19/051,625

(22) Filed: Feb. 12, 2025

(51) Int. Cl. G01R 31/3183; G01R 31/317; G01R 31/319

(52) U.S. Cl. CPC G01R 31/318314; G01R 31/31725; G01R 31/31917

(57) ABSTRACT

A method for functional verification of a circuit design under test (DUT), comprises: generating stimulus inputs for first and second DUT instances instantiated for testing using a functional verification test bench, where the first and second DUT instances are each based on a same functional design for the circuit DUT comprising at least one clock gate configured to control, based on a clock gating control input, whether a clock signal is enabled or disabled for downstream circuitry, and the stimulus inputs comprise at least one clock gating control input being set differently for the first and second DUT instances and non-clock-gating control inputs set identically for the first and second DUT instances; using the functional verification test bench, stimulating a response of the first and second DUT instances to the stimulus inputs, to obtain test outputs for the first and second DUT instances; and using at least one output checker, comparing at least one pair of corresponding test outputs for the first and second DUT instances, to detect whether there is divergence between behaviour of the first and second DUT instances.

### BACKGROUND

### Technical Field

The present technique relates to the field of circuit design verification.

### Technical Background

Circuit design verification is used in development of integrated circuit designs to test whether a design for an integrated circuit (or a sub-unit within an integrated circuit) meets its intended specifications and functional requirements. With complex integrated circuits comprising many millions of logic gates, design bugs in the functional design of the circuit are inevitable. If those errors persist in the final circuit design sent for manufacture, the manufactured chips may fail to adequately carry out their function, which can be costly to rectify. The complexity of integrated circuit designs means it is not generally feasible for verification to be performed manually by a human, and so automated testing methods are typically used.

### SUMMARY

At least some examples of the present technique provide a method for functional verification of a circuit design under test (DUT), comprising: generating stimulus inputs for first and second DUT instances instantiated for testing using a functional verification test bench, where the first and second DUT instances are each based on a same functional design for the circuit DUT comprising at least one clock gate configured to control, based on a clock gating control input, whether a clock signal is enabled or disabled for downstream circuitry, and the stimulus inputs comprise at least one clock gating control input being set differently for the first and second DUT instances and non-clock-gating control inputs set identically for the first and second DUT instances; using the functional verification test bench, stimulating a response of the first and second DUT instances to the stimulus inputs, to obtain test outputs for the first and second DUT instances; and using at least one output checker, comparing at least one pair of corresponding test outputs for the first and second DUT instances, to detect whether there is divergence between behaviour of the first and second DUT instances.

At least some examples of the present technique provide a non-transitory storage medium storing computer-readable code configured to control a computer to perform the method described above.

At least some examples of the present technique provide an apparatus configured to perform the method described above.

Further aspects, features and advantages of the present technique will be apparent from the following description of examples, which is to be read in conjunction with the accompanying drawings.

### BRIEF DESCRIPTION OF THE DRAWINGS

FIG. 1 illustrates an example of use of clock gates to enable or disable a clock signal to a portion of an integrated circuit;

FIG. 2 illustrates an example of a test bench for functional verification;

FIG. 3 illustrates an example of a functional verification approach for testing a clock gated circuit design;

FIG. 4 illustrates use of a chicken bit to select whether a given clock gate is in a clock-gating state or non-clock-gating state;

FIG. 5 illustrates a method for functional verification;

FIG. 6 illustrates use of the method of FIG. 5 as part of a verification testing strategy;

FIG. 7 illustrates an example of an integrated circuit design having redundant processors and lockstep checker circuitry; and

FIG. 8 illustrates an apparatus.

### DESCRIPTION OF EXAMPLES

One approach used in design verification is formal verification, in which the functional correctness of a design is verified using mathematical proofs. Formal verification methods verify mathematically that a functional model of the design meets certain criteria or is functionally equivalent to a reference design. However, while formal verification methods can be rigorous, enabling complete exploration of a full state space (all possible states and transitions) of a given circuit design, formal methods are typically only feasible for less complex circuit designs as with more complex circuit designs the explosion of state space means the computation cost and complexity of applying formal verification would be prohibitive.

Another approach is functional verification, in which the correctness of a circuit design under test (DUT) is tested by stimulating a model of the design on a test bench, and checking test outputs generated by the model in response to the stimulus (in contrast, formal verification methods do not involve stimulating a model of the DUT to generate test outputs based on stimulus inputs). While the stimulus input patterns may not cover the entire state space of the DUT, functional verification may enable testing of more complex designs that would be infeasible to test using formal verification alone.

Some circuit designs may use clock gating, in which a clock gate controls, based on a clock gating control input, whether a clock signal is enabled or disabled for downstream circuitry. Clock gating can easily introduce functional bugs in the design, as a design may not behave correctly if different parts of the design are clock gated under different conditions. For example, clock gating may prevent some tracking logic being updated or read at the correct timing for controlling other portions of the design. Formal verification approaches to analyzing effects of clock gating are limited by the compute and state space of the design, so do not usually go deep enough to test more complicated scenarios. On the other hand current functional verification approaches are typically limited to testing whether test outputs meet certain pre-defined architectural or micro-architectural requirements.

In examples discussed below, a method for functional verification is provided for verifying correctness of a circuit design under test (DUT). For example, the circuit DUT could be for an entire processor (e.g. a central processing unit, CPU), a sub-unit within a processor, or a system comprising at least one processor. The method comprises generating stimulus inputs for first and second DUT instances instantiated for testing using a functional verification test bench, where the first and second DUT instances are each based on a same functional design for the circuit DUT comprising at least one clock gate configured to control, based on a clock gating control input, whether a clock signal is enabled or disabled for downstream circuitry. The stimulus inputs comprise at least one clock gating control input being set differently for the first and second DUT instances and non-clock-gating control inputs set identically for the first and second DUT instances. The method comprises stimulating, using the functional verification test bench, a response of the first and second DUT instances to the stimulus inputs, to obtain test outputs for the first and second DUT instances. At least one output checker is used to compare at least one pair of corresponding test outputs for the first and second DUT instances, to detect whether there is divergence between behaviour of the first and second DUT instances.

With this approach, design errors caused by introduction of clock gating can be detected more effectively, as the functional verification testing can go deeper into more complex designs than would be feasible using formal verification. By testing whether first and second DUT instances stimulated using different clock gating settings give diverging test outputs in response to the same non-clock-gating control stimulus, even relatively complex circuit designs can be tested for clock gating design errors.

In some examples, the test outputs comprise external interface pin outputs corresponding to outputs to be exposed over external interface pins in the circuit DUT, and the at least one output checker comprises at least one interface checker configured to compare corresponding external interface pin outputs for the first and second DUT instances. The external interface pins can be a convenient location to implement checkers because a variety of types of error occurring at internal nodes of the design may propagate through to differences in the external interface pin outputs, and so relatively few checkers provided for checking the external interface pin outputs may provide a reasonable functional error coverage.

In some examples, the test outputs comprise internal outputs corresponding to outputs which are not exposed via external interface pins in the circuit DUT, and the at least one output checker comprises (either in combination with the at least one interface checker, or instead of the at least one interface checker) at least one internal output checker configured to compare corresponding internal outputs for the first and second DUT instances. Although the interface checkers can catch many sources of error introduced due to clock gating, they may not catch all errors as some errors arising at internal signal nodes may not necessarily propagate through to differences at the external interface pin outputs, but nevertheless may be bugs worth catching because even if they did not cause incorrect external interface pin outputs for the tested stimulus input patterns, the bugs could cause incorrect results for other non-tested stimulus inputs. By implementing internal output checkers which compare corresponding internal outputs of the first and second DUT instances when stimulated based on different clock gating control input settings, this provides additional error detection coverage, which can be particularly valuable for functional verification which, due to computational and operational overheads, will typically be limited in the stimulus input space that can feasibly be explored. Hence, the internal output checkers can enable greater error detection capability for a given fraction of the stimulus input space that is able to be tested in the functional verification method.

In some examples, the at least one internal output checker comprises at least one D flip-flop checker, where each D flip-flop checker is configured to compare data outputs for a pair of corresponding D flip-flops of the first and second DUT instances, to determine, in a cycle in which both of the pair of corresponding D flip-flops are enabled to update their data output based on a data input in response to a predetermined transition of the clock signal, whether there is divergence between the data outputs of the pair of corresponding D flip-flops. Implementing the internal output checkers corresponding to D flip-flops of the design can offer a good proxy for checking the functional behaviour of the entire design, limiting checking overhead in comparison to approaches which introduce more fine-grained checking of each individual circuit component on a signal path between a pair of D flip-flops. Hence, providing internal output checkers for checking D flip-flop outputs may provide a better balance between testing overhead and error coverage.

It might be thought that it would be infeasible to implement internal output checkers throughout the circuit DUT to check outputs of each D flip-flop or other internal node of the first and second DUT instances. However, in some examples, the method comprises automatically generating, based on a software program, a plurality of the output checkers corresponding to respective pairs of corresponding test outputs of the first and second DUT instances. In particular, at least the internal output checkers may be generated automatically based on the software program. The program may parse the first and second DUT instances to automatically identify respective pairs of corresponding test outputs to be checked. For example, the program may identify pairs of corresponding D flip-flops of the first and second DUT instances. The program may define, in a generalized manner, the checker functionality to be applied when a pair of corresponding D flip-flops of the first and second DUT instances are generated. By automating the checker generation, it becomes feasible to implement checkers at many internal nodes of the first and second DUT instances (which are too numerous to be practical to define checkers manually), enabling much greater error coverage to allow deeper sources of clock-gating-related design bugs to be probed.

In some examples, the stimulus inputs are generated to select, for the second DUT instance, clock gating control inputs which cause the clock signal to be enabled for a first portion of the second DUT instance and to be disabled for a second portion of the second DUT instance. Hence, the clock gating control used in functional verification testing can be more fine-grained than merely fully enabling or fully disabling the clock signals to a given DUT instance. This enables much deeper probing of design bugs which yield errors when one part of the circuit design has its clock signal enabled while another part of the circuit design has its clock signal disabled.

In some examples, at least a subset of the stimulus inputs comprise randomly generated stimulus inputs. The randomly generated stimulus inputs may be generated based on a set of one or more random or pseudorandom numbers. The randomization could be fully random, or could be random within a set of predefined constraints. The stimulus inputs may cover a randomly selected subset of stimulus input space.

In some examples, the first DUT instance could also have its clock gating control inputs varied (e.g. randomly), to control which clock gates enable/disable the corresponding clock signals.

However, in some examples, the stimulus inputs are generated to select, for the first DUT instance, stimulus inputs which cause the clock signal to the first DUT instance to be fully enabled, and to select, for the second DUT instance, stimulus inputs which cause the clock signal to be disabled for at least one portion of the second DUT instance. By fully enabling clock signals for the first DUT instance (i.e. causing the first DUT instance to function as if the clock gates were not provided), this can provide a useful reference model for comparing whether the second DUT instance (stimulated based on different clock gating settings) is behaving correctly.

In some examples, generating the stimulus inputs comprises randomly generating the at least one clock gating control input for the second DUT instance (e.g. based on a set of one or more random or pseudorandom numbers), to select a subset of clock gates of the second DUT instance to operate in a clock-signal-disabled state. The subset of clock gates of the second DUT instance which operate in a clock-signal-disabled state may be a proper subset, so that the second DUT instance has at least one clock gate in a clock-signal-enabled state and at least one clock gate in the clock-signal-disabled state.

In some examples, the circuit DUT to be verified comprises chicken bit circuitry responsive to at least one chicken bit input to select whether a given clock gate is in a clock-gating state in which the given clock gate controls whether to enable or disable the clock signal to the downstream circuitry based on a corresponding clock gating control input, or a non-clock-gating state in which the given clock gate controls the clock signal to be enabled for the downstream circuitry regardless of a current setting for the corresponding clock gating control input; and the stimulus inputs comprise different settings for the at least one chicken bit input for the first and second DUT instances. Some examples may provide a hierarchical set of chicken bits which control whether different layers of clock gates within the circuit DUT are in the clock-gating state or non-clock-gating state. A chicken bit is a circuit design feature that allows another feature of the circuit to be disabled if needed. Each chicken bit input can be software-programmable (E.g. by a tool/environment that is generating the stimulus for the DUT) or can be driven from an input/output (I/O) interface of the DUT. By introducing chicken bits into the design to control the clock gates to be enabled/disabled when required for testing on the test bench, this provides a simpler way of controlling the first and second DUT instances to be stimulated with different clock gating control inputs.

The first and second DUT instances can be instantiated in different ways. In some examples, instantiating the first and second DUT instances comprises duplicating a representation of the circuit DUT. This can be useful for testing circuit designs which do not already have redundant components which could be driven with different clock gating stimulus inputs.

However, in some examples, such duplication of a circuit DUT may not be needed. Some circuit DUTs may comprise a design for a lockstep processing apparatus comprising a plurality of redundant circuit components and lockstep checker circuitry configured to detect divergence between outputs of the plurality of redundant circuit components (such circuit designs can be useful for scenarios where functional safety guarantees are needed, such as in automotive or aerospace applications). The circuit component implemented redundantly two or more times could include a processor (e.g. CPU), or could be other circuit logic whose operation affects safe functioning of the DUT. In this case, the first and second DUT instances may comprise first and second redundant circuit components of the circuit DUT to be verified; and the lockstep checker circuitry of the circuit DUT may be reused as an output checker to detect divergence between behaviour of the first and second redundant circuit components when stimulated with different settings for the at least one clock gating control input. By reusing the existing redundancy and checker circuitry of a lockstep processing circuit design when possible, this limits the overhead of the functional verification testing, providing a more efficient test method.

In some examples, the stimulus inputs for the first and second DUT instances comprise stimulus inputs to represent a sequence of software test library (STL) instructions to be executed on the first and second DUT instances. A STL provides a sequence of instructions which can be executed on a processor for online testing when the processor is operational having been manufactured. While STLs are typically designed to probe for errors (e.g. caused by age-related deterioration of semiconductor devices) arising when the device is operational post-manufacture, as they are designed to probe a wide variety of commonly occurring bugs they can also be useful for generating the stimulus inputs during functional verification of the circuit DUT pre-manufacture. Hence, at least part of the stimulus inputs may correspond to a set of instructions of a STL designed for runtime operational testing. By reusing a STL to generate at least part of the stimulus inputs for the first and second DUTs, this can provide better error coverage for a given amount of verification overhead.

The functional verification test bench can be implemented in different ways. In some examples, the functional verification test bench comprises a simulation environment for simulating behaviour of the first and second DUT instances to obtain the test outputs in response to the stimulus inputs. For example, the first and second DUT instances may be represented using a hardware description language, such as SystemVerilog for instance. Parts of the test bench (such as the stimulus generator and/or output checkers) may similarly be represented using the hardware description language. The test bench may enable the response of the first and second DUT instances to a given set of stimulus inputs to be simulated in software, to simulate how logic gates and other internal components of the first and second DUT instances generate corresponding test outputs based on the stimulus inputs, and compare test outputs at external interfaces and/or internal signal nodes to generate an indication of whether any divergent behaviour has been detected.

In other examples, the functional verification test bench comprises a hardware emulation environment, with the first and second DUT instances instantiated as respective portions of a hardware model for testing the circuit DUT. For example, the hardware emulation environment may comprise a field programmable gate array (FPGA) which has been configured to model the first and second DUT instances and provide the output checkers for comparing external interface pin outputs or internal test outputs within the first and second DUT instances. Hence, the techniques discussed above can also apply within a hardware emulation test bench.

In some examples, the method is at least partly automated, e.g. with at least one of the steps of the method (e.g. the step of stimulating the response and/or comparing the test outputs) performed using an EDA (electronic design automation) tool.

In some examples, a non-transitory storage medium stores computer-readable code configured to control a computer to perform the method described above.

In some examples, the circuit DUT may be represented using a hardware description language, such as SystemVerilog. The test bench may also be represented in the hardware description language. An EDA tool may be used to simulate behaviour of the circuit DUT and the test bench to obtain the test outputs and perform the comparison of the test outputs using the output checkers.

Specific examples are now described with reference to the drawings.

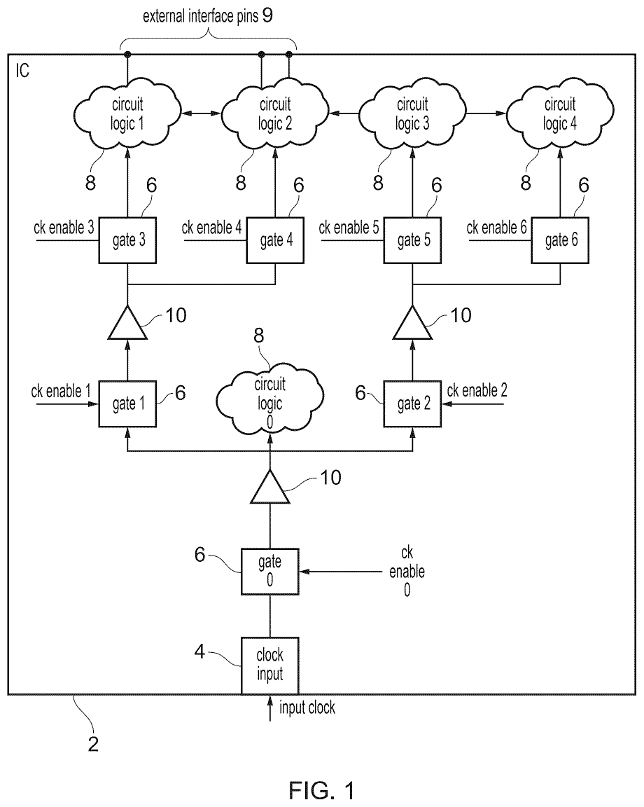

FIG. 1 illustrates an example of use of clock gating in an integrated circuit 2. The circuit 2 comprises a number of portions of circuit logic 8, each clocked based on a clock signal supplied from a clock input node 4. Clock gates 6 are provided to control, based on a corresponding clock gating control signal (clock enable signal) whether the clock signal for a downstream portion of circuitry is enabled or disabled. The integrated circuit 2 may also include some clock buffers 10 on the paths by which clock signals propagate to circuit logic 8, for boosting signal levels of the clock signal by repeating the input clock signal as the output clock signal. Some instances of circuit logic 8 may output signals via external interface pins 9 of the integrated circuit 2, to expose their outputs for reading by external devices.

When the clock signal for a downstream portion of circuit logic 8 beyond a given clock gate 6 is enabled, clock edges of the input clock propagate beyond the clock gate 6 to trigger corresponding actions at the downstream circuit logic 8. When the clock signal is disabled by a given clock gate 6, any edges of the input clock do not propagate beyond the clock gate, so that the output clock propagated beyond the clock gate 6 is clamped to a fixed value, and so any edge-triggered circuit elements in the downstream circuit logic 8 remain in a static state. This helps reduce power consumption in a downstream portion of circuit logic 8 which is not needed for a time.

As shown in FIG. 1, clock gates 6 may be implemented in a hierarchical manner, with an earlier level of clock gate 6 controlling whether the clock signal is enabled or disabled for a given region of downstream circuitry and one or more subsequent levels of clock gates 6 controlling independent enabling/disabling of the clock signals for specific sub-regions of the given region of downstream circuitry. For example, in FIG. 1 clock gate 0 controls the output clock to the entire integrated circuit 2, clock gate 1 controls the output clock to circuit logic 1 and 2 (but not circuit logic 0, 3 and 4), and clock gate 3 controls the output clock to circuit logic 1 (but not circuit logic 2), so that clock gates 0, 1 and 3 form a hierarchy of clock gates (with clock gate 0 offering coarser-grained control and clock gates 1 and 3 offering successively finer-grained levels of control). The clock gating control signal (clock enable signal) for a given clock gate 6 could be generated externally and supplied to the integrated circuit 2 via an external interface pin of the integrated circuit 2, or generated internally by circuit logic 8 of the integrated circuit 2 (e.g. a power management component could generate the clock gating control signals for the clock gates 6 based on current status of the integrated circuit 2).

The integrated circuit 2 could provide a complete design for a processor, such as a CPU (central processing unit), or could be a design for a specific sub-unit within a processor, e.g. circuitry for implementing specific functionality such as instruction decoding, load/store processing, a cache unit, floating-point arithmetic, etc.

It will be appreciated that FIG. 1 is a simplified representation of an integrated circuit provided for illustrating the principle of clock gating, and in practice circuit designs may be greatly more complex. The specific hierarchy of clock gates 6 controlling clock supply to respective circuit logic instances 8 in FIG. 1 is just one example, and it will be appreciated that the particular number of clock gating levels and clock gates provided in a clock tree by which clock signals are supplied to integrated circuit logic components 8 could vary.

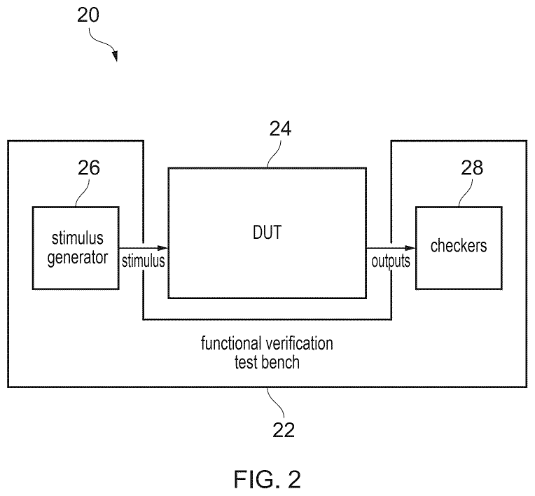

FIG. 2 schematically illustrates an example of a verification environment 20 for performing functional verification. The environment 20 comprises a functional verification test bench 22, for performing functional verification of an integrated circuit design under test (DUT) 24. A representation of the DUT 24 is instantiated on the test bench 22. The test bench 22 comprises a stimulus generator 26 which generates a set of stimulus inputs for inputting to a model of the DUT 24 to stimulate a response which causes output of one or more test outputs. The test bench 22 also includes output checkers 28 switch to check whether the test outputs meet verification criteria.

In some examples, the verification environment 20 is a hardware-implemented verification apparatus, with the DUT 24 to be tested emulated in hardware using a configurable circuit such as a field programmable gate array which can be programmed to model, at a given level of abstraction, the behaviour of the DUT 24 to be tested. The test bench hardware 22 may comprise a stimulus generator 26 to stimulate the hardware model with the stimulus inputs and the checkers 28 compare the resulting test outputs using the checkers 28.

In other examples, the verification environment 20 is a software environment (e.g. provided by an EDA tool), with both the DUT 24 itself and the test bench 22 implemented in software. For example, the DUT 24 can be represented functionally using a hardware description language such as RTL or SystemVerilog, which logically represents the data flow through the DUT 24, e.g. defining logical (e.g. Boolean) functions for combining signals or representing logic gates. At least part of the test bench 22 (e.g. the stimulus generator 26 and/or the checkers 28) may be represented using the same description language as the DUT 24 itself, or represented using a different description language. The test environment 20 may have the capability to simulate the response of the DUT 24 to a particular set of stimulus inputs, to generate the corresponding test outputs (e.g. by evaluating the output of each gate based on its inputs in each cycle of simulated operation of the DUT 24).

Regardless of whether the verification environment 20 is implemented in hardware or software, the stimulus inputs 26 may include a time series of sets of stimulus inputs to be input across multiple cycles of operation of the DUT 24, and the test outputs generated in response to the stimulus inputs may be collected across multiple cycles of operation. For a given cycle of operation, the stimulus inputs may comprise bit values to be input at various input interface pins of the DUT 24 and/or instructions to be simulated as being executed in a given cycle. The checkers 28 may check various predefined criteria, such as whether a test output matches the expected behaviour defined in a design specification, or whether a given logical and/or temporal relation between stimulus inputs and test outputs, or between respective test outputs, has been satisfied. If the test outputs do not meet the required criteria, then a verification error can be signaled which may prompt a design engineer to review the verification results and consider whether a modification to the circuit design is needed.

There can be a significant technical challenge in implementing circuit design verification in an integrated circuit design which uses clock gating. Clock gates 6 may often be introduced relatively late in the design flow once the design for the functional circuit logic 8 of the integrated circuit 2 has been established, and the introduction of clock gating may introduce additional sources of functional bugs into the design due to different portions of the design being clock gated on different conditions such that some logic may not be updated or read at the appropriate timing. Such bugs arising on relatively complex integrated circuit designs can escape traditional verification checks, because most clock gating checks are based on formal verification to verify, based on mathematical proofs applied to a state transition model of the DUT, whether a clock-gated circuit design is functionally equivalent to a prior non-clock-gated design-such approaches are limited in practice to simpler integrated circuit designs because otherwise the state space to be formally proved safe vastly explodes with increasing circuit design complexity. Unlike functional verification methods, such formal verification methods do not apply any stimulus to a simulated/emulated model of the DUT. On the other hand, typical functional verification methods, if applied to clock gating, may merely provide checkers for verifying certain architectural requirements of the clock gates, such as whether a downstream clock gated component has indeed suppressed its output when the clock gating control input has been set to disable the clock. However, this fails to probe functional bugs which may arise due to inter-clock-gating behaviours relating to the timing of interaction of different portions of circuitry controlled by different clock gating settings (e.g. where circuit logic X transmits a signal to circuit logic Y which fails to update a tracker because it currently has its clock disabled, and then in a later cycle when circuit logic Y is operational again circuit logic X and Y continue to operate based on mismatched trackers risking error).

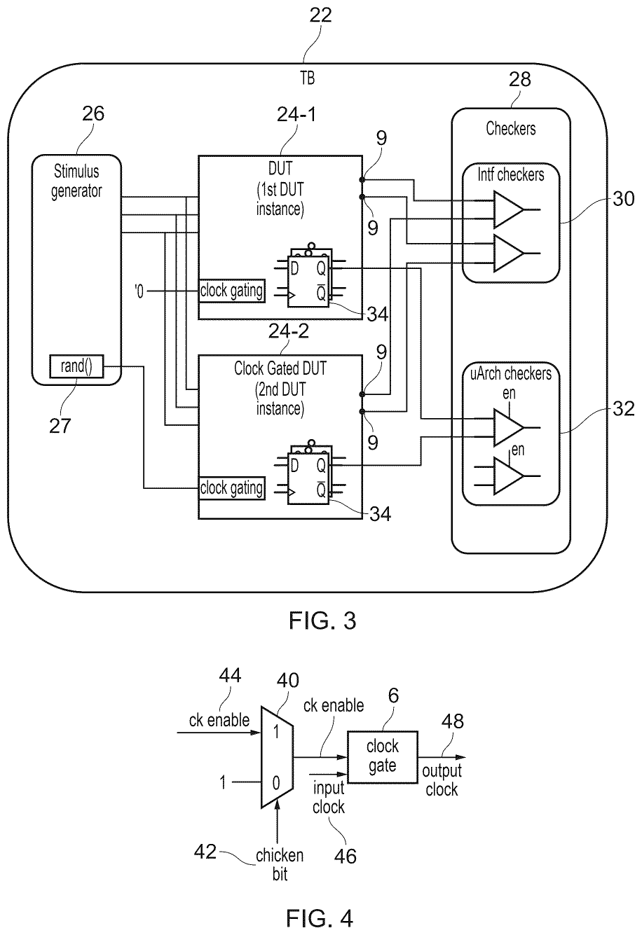

FIG. 3 illustrates functional verification approach for deeper probing of clock-gating-related functional design bugs. Again, the test bench 22 comprises a stimulus generator 26 and output checkers 28. With this approach, two instances of the DUT are instantiated on the test bench 22: a first DUT instance 24-1 and a second DUT instance 24-2. The first and second DUT instances 24-1, 24-2 are functionally identical, so represent the same combinations of circuit logic including both the functional circuit logic 8 and the clock gates 6. For example, during testing the test environment 20 duplicates a representation of the integrated circuit design to be tested, to provide a model of the DUT which is twice the size, with redundant versions of each component of the DUT.

During verification testing, the stimulus generator 26 generates stimulus inputs for each of the first and second DUT instances 24-1, 24-2, with any non-clock-gating stimulus inputs being the same for each of the first and second DUT instances 24-1, 24-2, and at least one clock-gating stimulus input (which influences the clock enable signal input to at least one clock gate 6) set to different settings for the first and second DUT instances 24-1, 24-2 respectively. For example, as shown in FIG. 3, all clock gating inputs for the first DUT instance could be set to a fixed value (e.g. 0) which causes all portions of circuit logic of the first DUT instance 24-1 to have their clock signal fully enabled so that the first DUT instance 24-1 is fully operational-this provides a convenient reference model for comparing the effects of varying clock gating settings in the second DUT instance 24-2. On the other hand, the stimulus inputs for the second DUT instance 24-2 may be set, e.g. based on a random or pseudorandom input, to control at least one portion of the second DUT instance 24-2 to be in a clock-enabled state and at least one further portion of the second DUT instance 24-2 to be in a clock-disabled state. The variation (e.g. randomisation) of the clock gating stimulus inputs for the second DUT instance 24-2 can include both a spatial variation (varying which particular regions of the second DUT instance 24-2 have their clocks disabled) and a temporal variation (varying the relative timings at which the clock signal to a given region of the second DUT instance 24-2 is enabled or disabled).

In some examples, the clock-gating stimulus inputs for the DUT instances 24-1, 24-2 may directly specify clock gating control inputs (clock enable signals) for particular clock gates 6. This may be appropriate for a clock gate whose clock gating control input is supplied via an external interface pin. However, for clock gates 6 which are controlled based on internally generated clock gating control inputs, there may not necessarily be an available signal path in the representation of the DUT by which that clock gating control input can be stimulated with a particular setting from the outside.

As shown in FIG. 4, to support arbitrary settings for whether clock gates are enabled or disabled, it can be useful for the DUT 24 to be provided with chicken bit circuitry 40 which is responsive to at least one chicken bit input 42 to select whether a given clock gate 6 is in a clock-gating state in which the given clock gate controls whether to enable or disable the clock signal 48 to the downstream circuitry based on a corresponding clock gating control input 44, or a non-clock-gating state in which the given clock gate controls the clock signal to be enabled for the downstream circuitry regardless of a current setting for the corresponding clock gating control input 44. For example, in FIG. 4, for a given clock gate 6 controlled by the chicken bit circuitry 40, when the chicken bit input 42 is 1 then the clock gate 6 is in the clock-gating state and when the chicken bit input 42 is 0 then the clock gate 6 is in the non-clock-gating state (the chicken bit circuitry 40 in this example being implemented using a multiplexer which propagates the clock gating control signal 44 through to the clock gate 6 when the chicken bit signal is 1 and clamps the clock gating control signal 44 supplied to the clock gate 6 to 1 if the chicken bit signal is 0). It will be appreciated that this is just one possible implementation of the chicken bit circuitry 40, and other circuit designs could implement a similar functionality.

The chicken bit circuitry 40 for each clock gate 6 may be driven based on chicken bits input into the DUT via (simulated or emulated) external interface pins. A single instance of chicken bit circuitry 40 (controlled by a shared chicken bit 42) may be shared between more than one clock gate 6, to control in common whether two or more clock gates are each placed in the clock-gating state or non-clock-gating state. Two or more distinct chicken bits 42 may be provided to separately control whether corresponding subsets of clock gates are in the clock-gating state or non-clock-gating state. In some cases the chicken bit circuitry 40 may be implemented hierarchically, in a similar way to the hierarchical clock tree shown in FIG. 1, so that a higher-level instance of chicken-bit circuitry 40 may control the clock gates for a larger portion of the DUT 24 than a lower-level instance of chicken-bit circuitry 40 corresponding to clock gates in a smaller portion of the DUT 24.

Hence, chicken bits can be implemented to provide fine-grained control over whether the clock-gating functionality 6 of the circuitry is active or not for respective regions of the DUT 24. The chicken bit circuitry 40 may be included in the DUT 24 as a “design for test” feature which may ultimately be manufactured as part of the manufactured integrated circuit corresponding to the DUT (if signed off based on functional verification), but which is included primarily to facilitate testing of the DUT during the EDA process. As well as providing support for the clock-gating functional verification method described here, the chicken bit circuitry 40 may also be useful for, post-manufacture, disabling certain clock gates if suffering from manufacturing defects introduced in the manufacturing process.

Returning to the discussion of FIG. 3, based on the sets of stimulus inputs generated for the first and second DUT instances 24-1, 24-2, each of the first and second DUT instances 24-1, 24-2 is stimulated to generate a corresponding set of test outputs as a response to the stimulus. This could be done either by stimulating a hardware model of the DUT instances or by simulating the behaviour of the DUT instances 24-1, 24-2 in a software verification environment. Corresponding pairs of test outputs generated by the first and second DUT instances 24-1, 24-2 are compared by the output checkers 28 to detect divergence in behaviour between the first and second DUT instances 24-1, 24-2. If there is a divergence in behaviour when stimulated based on identical non-clock-gating stimulus inputs but differing clock-gating stimulus inputs, it is likely (but not guaranteed) that the differences in clock gating settings could be a cause of such divergent behaviour, and a verification engineer can review the cause of the divergence and liaise with a circuit design team to propose any modification to the design to improve functional correctness (e.g. to modify a portion of the design to include safeguards against another component being in a clock-disabled state at the time when that other component is sent information).

As shown in FIG. 3, the output checkers 28 may include interface checkers 30 which compare corresponding pairs of external pin test outputs output over external interface pins 9 of the first and second DUT instances 24-1, 24-2, and internal output checkers 32 which compare test outputs corresponding to internal signal nodes of the first and second DUT instances 24-1, 24-2 whose outputs would not, in the ultimate circuit design, be exposed over the external interface pins 9. By including the internal output checkers 32 for checking the internal signal nodes, much deeper testing becomes feasible, enabling identification of classes of functional bug which could not be detected from the external interface checkers 30 alone.

For example, as shown in FIG. 3, each internal output checker 32 may check the output signals output by corresponding D flip-flops 34 of the first and second DUT instances. A D flip-flop has a data input D and differential outputs (Q and its inverse), an enable input en, and a clock input. In response to a predetermined transition of the clock input (either a rising edge or a falling edge), the D flip-flop propagates the input D to the output Q if the enable input en is high and retains the previous value of the output Q (irrespective of its input D) if the enable input en is low. For a given pair of D flip flops 34 at corresponding locations in the first and second DUT instances 24-1, 24-2, the corresponding output checker 32 compares the flop outputs Q in cycles when both enable signals for the pair of D flip flops 34 are high and provides a verification signal indicating whether any divergence is detected between the flop outputs Q (if one or both of the pair of D flip flops 34 has its enable signal low, then either no comparison is performed, or a comparison is performed but no verification error is signaled even if there is a mismatch between the outputs Q of the pair of D flip flops 34 in that cycle).

A challenge with implementing the internal output checkers 32 is that the number of D flip-flops 34 in the DUT is vastly greater than the number of external interface pins 9, making it infeasible to manually identify each D flip-flop 34 (or even a fraction of the D flip-flops) in the design and manually define checker conditions for implementing the checkers 32 for each of those flip-flops 34. However, the inventors have proposed automatically generating a logic representation for implementing the internal output checkers 32 using a software program which automatically parses the first and second DUT instances 24-1, 24-2 to identify corresponding pairs of D flip-flops 34 and generates the corresponding checker logic 32 to be instantiated in the checker 28 part of the design. With this approach, it becomes feasible to implement deep probing of a relatively complex design to compare outputs of many pairs of D flip-flops 34 at internal signal nodes which are not exposed via external interface pins, enabling much greater verification coverage to increase the likelihood that clock-gating-related functional bugs can be detected.

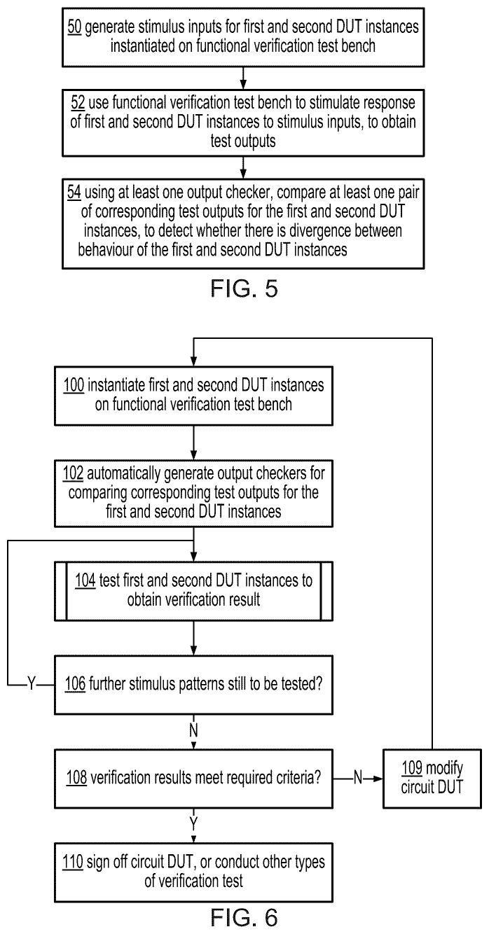

FIG. 5 illustrates a method for functional verification for testing a given circuit DUT. At step 50, the stimulus generator 26 generates stimulus inputs for the first and second DUT instances 24-1, 24-2 instantiated on a functional verification test bench 22. The first and second DUT instances are each based on a same functional design for the circuit DUT comprising at least one clock gate 6, and the stimulus inputs comprise at least one clock gating control input (e.g. the clock enable signal 44 and/or one or more chicken bits 42) being set differently for the first and second DUT instances and non-clock-gating control inputs set identically for the first and second DUT instances. At step 52, the functional verification test bench 22 is used to stimulate a response of the first and second DUT instances 24-1, 24-2 to the stimulus inputs, to obtain test outputs. At step 54, at least one output checker 28 is used to compare at least one pair of corresponding test outputs for the first and second DUT instances 24-1, 24-2, to detect whether there is divergence between the behaviour of the first and second DUT instances in response to the stimulus. If divergence is detected, this may be an indication that introduction of clock gating has a caused a functional bug, which may need investigation and, if appropriate, rectification by modifying the circuit DUT.

FIG. 6 illustrates a verification flow including the method of FIG. 5. The method can be performed by an EDA tool, for example. At step 100, the first and second DUT instances 24-1, 24-2 are instantiated on a functional verification test bench 22, e.g. by duplicating a hardware description language representation of the circuit DUT to form the first and second DUT instances, or by generating control inputs for configuring a FPGA or other hardware model for emulating the circuit DUT. At step 102, output checkers 28 for comparing corresponding test outputs for the first and second DUT instances are automatically generated based on a software program (e.g. a script), which parses the first and second DUT instance representations to identify corresponding internal test outputs for comparison, and generates the checker logic for comparing those internal test outputs. If a hardware model is used to emulate the circuit DUT, then control inputs for configuring the hardware model (e.g. FPGA) to act as the checkers may be generated.

At step 104, steps 50, 52, 54 of FIG. 5 are performed to test the first and second DUT instances for a given stimulus input pattern and obtain a verification result dependent on whether any divergence was detected by the output checkers 28. At step 106, it is determined whether there are further stimulus pattern still to be tested, and if so then step 104 is repeated to generate further verification results. Once all desired stimulus patterns have been tested, then at step 108, it is determined whether the verification results meet the required criteria, and if not then an error report is generated which can be passed to the circuit design team who at step 109 may make a modification to the circuit DUT. The method can then be repeated from step 100 for the modified circuit DUT. Eventually, once all verification results are deemed to meet the required criteria, then at step 110 the circuit DUT is signed off as verified, or alternatively other types of verification test, such as formal verification, may be conducted before signing off the circuit design.

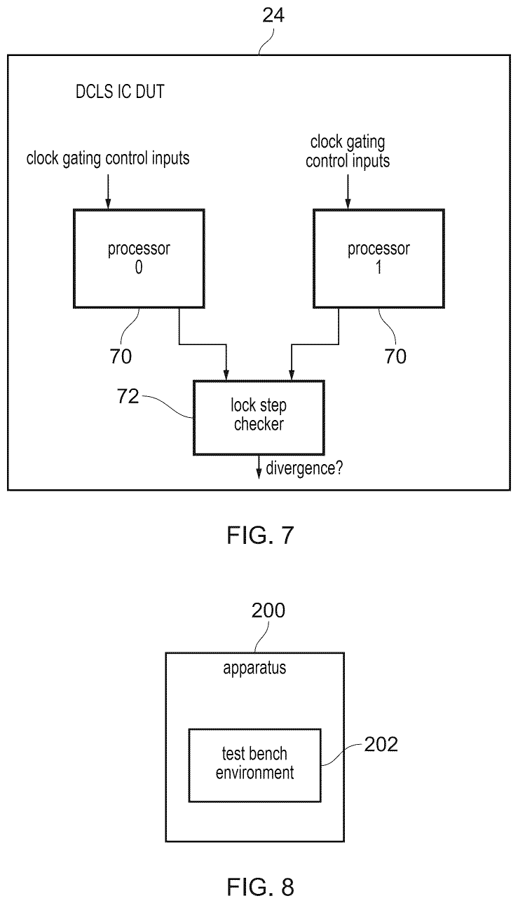

FIG. 7 illustrates an example of an integrated circuit design 24 which uses a “dual core lockstep” (DCLS) technique for guaranteeing functional safety. The integrated circuit comprises two redundant processors 70, which when in use in the field are supplied with identical input signals so as to redundantly perform the same task as each other (in some cases, with a time offset between the time at which processor 0 performs the task and the timer which processor 1 performs the task, to reduce the likelihood of common mode failures where a single event such as a particle strike or power glitch affects both processors). A lockstep checker 72 is included to compare the outputs of the redundant processors 70, and signal an error if divergence is detected. While FIG. 7 shows an example with two redundant processors 70, other examples could have three or more redundant processors 70. Such a lockstep approach can be helpful for safety-critical applications such as processors used in automotive, aerospace or industrial applications.

If the circuit DUT 24 is for a lockstep apparatus having redundant processors 70, then the circuit DUT already includes components 70 with functionally identical circuit designs, and checker circuitry 72 for checking whether there is any divergence between the outputs of the those components. Hence, when performing functional verification on the circuit design to be used for the processors 70, there is no need to duplicate the circuit DUT 24 to form the first and second DUT instances 24-1, 24-2 described above, as instead the redundant processors 70 can be treated as the first and second DUT instances 24-1, 24-2, and the lockstep checker 72 already represented in the circuit DUT may act as at least one interface checker 30. Additional internal output checkers 32 may still be added during the step of instantiating the circuit DUT 24 on the test bench 22. The lockstep circuit DUT 24 may already have circuit logic for duplicating non-clock-gating inputs to be supplied redundantly to each redundant processor 70, but additional chicken bits or other “design for test” logic may be provided to support providing different clock gating control inputs to the respective redundant processors 70 so that inter-clock-gating effects between different components can be tested by using the lockstep checker 72 or other output checkers 28 to compare the response of the redundant processors 70 (first and second DUT instances 24-1, 24-2) to a common set of non-clock-gating stimulus inputs and different sets of clock-gating stimulus inputs.

Hence, in some instances the verification effort may be reduced when the circuit DUT 24 is a lockstep system, by reusing elements of the lockstep system as the redundant DUT instances 24-1, 24-2 and checkers 28 where possible.

While in the specific example of FIG. 7, the component implemented redundantly is a processor 70, in other examples a lockstep technique could be applied to other circuit components, so the lockstep technique is not limited to redundant processors.

FIG. 8 illustrates an apparatus 200 for performing the methods discussed above. The apparatus 200 comprises a test bench environment 202. For example, the apparatus 200 could be a computer or processor executing EDA tool software providing a test bench environment 202, or could be a hardware emulator or FPGA which has been configured, based on inputs generated based on the circuit DUT and the desired checker functions 28, to act as the test bench environment 202 and provide a hardware model of the circuit DUT.

Some examples are set out in the following clauses:
1. A method for functional verification of a circuit design under test (DUT), comprising:
   generating stimulus inputs for first and second DUT instances instantiated for testing using a functional verification test bench, where the first and second DUT instances are each based on a same functional design for the circuit DUT comprising at least one clock gate configured to control, based on a clock gating control input, whether a clock signal is enabled or disabled for downstream circuitry, and the stimulus inputs comprise at least one clock gating control input being set differently for the first and second DUT instances and non-clock-gating control inputs set identically for the first and second DUT instances;
   using the functional verification test bench, stimulating a response of the first and second DUT instances to the stimulus inputs, to obtain test outputs for the first and second DUT instances; and
   using at least one output checker, comparing at least one pair of corresponding test outputs for the first and second DUT instances, to detect whether there is divergence between behaviour of the first and second DUT instances.
2. The method of clause 1, in which the test outputs comprise external interface pin outputs corresponding to outputs to be exposed over external interface pins in the circuit DUT, and the at least one output checker comprises at least one interface checker configured to compare corresponding external interface pin outputs for the first and second DUT instances.
3. The method of any of clauses 1 and 2, in which the test outputs comprise internal outputs corresponding to outputs which are not exposed via external interface pins in the circuit DUT, and the at least one output checker comprises at least one internal output checker configured to compare corresponding internal outputs for the first and second DUT instances.
4. The method of clause 3, in which the at least one internal output checker comprises at least one D flip-flop checker,
   each D flip-flop checker configured to compare data outputs for a pair of corresponding D flip-flops of the first and second DUT instances, to determine, in a cycle in which both of the pair of corresponding D flip-flops are enabled to update their data output based on a data input in response to a predetermined transition of the clock signal, whether there is divergence between the data outputs of the pair of corresponding D flip-flops.
5. The method of any of clauses 1 to 4, comprising automatically generating, based on a software program, a plurality of the output checkers corresponding to respective pairs of corresponding test outputs of the first and second DUT instances.
6. The method of clause 5, in which the respective pairs of corresponding test outputs of the first and second DUT instances are automatically identified by executing the software program.
7. The method of any of clauses 1 to 6, in which the stimulus inputs are generated to select, for the second DUT instance, clock gating control inputs which cause the clock signal to be enabled for a first portion of the second DUT instance and to be disabled for a second portion of the second DUT instance.
8. The method of any of clauses 1 to 7, in which at least a subset of the stimulus inputs comprise randomly generated stimulus inputs.
9. The method of any of clauses 1 to 8, in which the stimulus inputs are generated to select, for the first DUT instance, stimulus inputs which cause the clock signal to the first DUT instance to be fully enabled, and to select, for the second DUT instance, stimulus inputs which cause the clock signal to be disabled for at least one portion of the second DUT instance.
10. The method of clause 9, in which generating the stimulus inputs comprises randomly generating the at least one clock gating control input for the second DUT instance, to select a subset of clock gates of the second DUT instance to operate in a clock-signal-disabled state.
11. The method of any of clauses 1 to 10, in which the circuit DUT to be verified comprises chicken bit circuitry responsive to at least one chicken bit input to select whether a given clock gate is in a clock-gating state in which the given clock gate controls whether to enable or disable the clock signal to the downstream circuitry based on a corresponding clock gating control input, or a non-clock-gating state in which the given clock gate controls the clock signal to be enabled for the downstream circuitry regardless of a current setting for the corresponding clock gating control input; and the stimulus inputs comprise different settings for the at least one chicken bit input for the first and second DUT instances.
12. The method of any of clauses 1 to 11, in which instantiating the first and second DUT instances comprises duplicating a representation of the circuit DUT.
13. The method of any of clauses 1 to 12, in which the circuit DUT to be verified comprises a design for a lockstep processing apparatus comprising a plurality of redundant circuit components and lockstep checker circuitry configured to detect divergence between outputs of the plurality of redundant circuit components; the first and second DUT instances comprise first and second redundant circuit components of the circuit DUT to be verified; and the comparing comprises reusing the lockstep checker circuitry of the circuit DUT as an output checker to detect divergence between behaviour of the first and second redundant circuit components when stimulated with different settings for the at least one clock gating control input.
14. The method of any of clauses 1 to 13, in which the stimulus inputs for the first and second DUT instances comprise stimulus inputs to represent a sequence of software test library instructions to be executed on the first and second DUT instances.
15. The method of any of clauses 1 to 14, in which the functional verification test bench comprises a simulation environment for simulating behaviour of the first and second DUT instances to obtain the test outputs in response to the stimulus inputs.
16. The method of any of clauses 1 to 14, in which the functional verification test bench comprises a hardware emulation environment, with the first and second DUT instances instantiated as respective portions of a hardware model for testing the circuit DUT.
17. A non-transitory storage medium storing computer-readable code configured to control a computer to perform the method of any of clauses 1 to 16.
18. An apparatus configured to perform the method of any of clauses 1 to 16.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. A method for functional verification of a circuit design under test (DUT), comprising:
generating stimulus inputs for first and second DUT instances instantiated for testing using a functional verification test bench, where the first and second DUT instances are each based on a same functional design for the circuit DUT comprising at least one clock gate configured to control, based on a clock gating control input, whether a clock signal is enabled or disabled for downstream circuitry, and the stimulus inputs comprise at least one clock gating control input being set differently for the first and second DUT instances and non-clock-gating control inputs set identically for the first and second DUT instances;
using the functional verification test bench, stimulating a response of the first and second DUT instances to the stimulus inputs, to obtain test outputs for the first and second DUT instances; and
using at least one output checker, comparing at least one pair of corresponding test outputs for the first and second DUT instances, to detect whether there is divergence between behaviour of the first and second DUT instances.

2. The method of claim 1, in which the test outputs comprise external interface pin outputs corresponding to outputs to be exposed over external interface pins in the circuit DUT, and the at least one output checker comprises at least one interface checker configured to compare corresponding external interface pin outputs for the first and second DUT instances.

3. The method of claim 1, in which the test outputs comprise internal outputs corresponding to outputs which are not exposed via external interface pins in the circuit DUT, and the at least one output checker comprises at least one internal output checker configured to compare corresponding internal outputs for the first and second DUT instances.

4. The method of claim 3, in which the at least one internal output checker comprises at least one D flip-flop checker,
each D flip-flop checker configured to compare data outputs for a pair of corresponding D flip-flops of the first and second DUT instances, to determine, in a cycle in which both of the pair of corresponding D flip-flops are enabled to update their data output based on a data input in response to a predetermined transition of the clock signal, whether there is divergence between the data outputs of the pair of corresponding D flip-flops.

5. The method of claim 1, comprising automatically generating, based on a software program, a plurality of the output checkers corresponding to respective pairs of corresponding test outputs of the first and second DUT instances.

6. The method of claim 5, in which the respective pairs of corresponding test outputs of the first and second DUT instances are automatically identified by executing the software program.

7. The method of claim 1, in which the stimulus inputs are generated to select, for the second DUT instance, clock gating control inputs which cause the clock signal to be enabled for a first portion of the second DUT instance and to be disabled for a second portion of the second DUT instance.

8. The method of claim 1, in which at least a subset of the stimulus inputs comprise randomly generated stimulus inputs.

9. The method of claim 1, in which the stimulus inputs are generated to select, for the first DUT instance, stimulus inputs which cause the clock signal to the first DUT instance to be fully enabled, and to select, for the second DUT instance, stimulus inputs which cause the clock signal to be disabled for at least one portion of the second DUT instance.

10. The method of claim 9, in which generating the stimulus inputs comprises randomly generating the at least one clock gating control input for the second DUT instance, to select a subset of clock gates of the second DUT instance to operate in a clock-signal-disabled state.

11. The method of claim 1, in which the circuit DUT to be verified comprises chicken bit circuitry responsive to at least one chicken bit input to select whether a given clock gate is in a clock-gating state in which the given clock gate controls whether to enable or disable the clock signal to the downstream circuitry based on a corresponding clock gating control input, or a non-clock-gating state in which the given clock gate controls the clock signal to be enabled for the downstream circuitry regardless of a current setting for the corresponding clock gating control input; and
the stimulus inputs comprise different settings for the at least one chicken bit input for the first and second DUT instances.

12. The method of claim 1, in which instantiating the first and second DUT instances comprises duplicating a representation of the circuit DUT.

13. The method of claim 1, in which the circuit DUT to be verified comprises a design for a lockstep processing apparatus comprising a plurality of redundant circuit components and lockstep checker circuitry configured to detect divergence between outputs of the plurality of circuit components;
the first and second DUT instances comprise first and second redundant circuit components of the circuit DUT to be verified; and
the comparing comprises reusing the lockstep checker circuitry of the circuit DUT as an output checker to detect divergence between behaviour of the first and second redundant circuit components when stimulated with different settings for the at least one clock gating control input.

14. The method of claim 1, in which the stimulus inputs for the first and second DUT instances comprise stimulus inputs to represent a sequence of software test library instructions to be executed on the first and second DUT instances.

15. The method of claim 1, in which the functional verification test bench comprises a simulation environment for simulating behaviour of the first and second DUT instances to obtain the test outputs in response to the stimulus inputs.

16. The method of claim 1, in which the functional verification test bench comprises a hardware emulation environment, with the first and second DUT instances instantiated as respective portions of a hardware model for testing the circuit DUT.

17. A non-transitory storage medium storing computer-readable code configured to control a computer to perform the method of claim 1.

18. An apparatus configured to perform the method of claim 1.
